(19) United States
(12) Patent Application Publication
(10) Pub. No.: US 2021/0356818 A1
(43) Pub. Date: Nov. 18, 2021

(54) PIXEL ELECTRODE STRUCTURE

(71) Applicant: Shenzhen China Star Optoelectronics Semiconductor Display Technology Co., Ltd., Shenzhen (CN)

(72) Inventor: Wu Cao, Shenzhen (CN)

(73) Assignee: Shenzhen China Star Optoelectronics Semiconductor Display Technology Co., Ltd., Shenzhen (CN)

(21) Appl. No.: 16/625,285

(22) PCT Filed: Dec. 17, 2019
(86) PCT No.: PCT/CN2019/126095

§ 371 Date: Dec. 20, 2019

(30) Foreign Application Priority Data
Oct. 29, 2019 (CN) 201911036519.4

(51) Int. Cl. G02F 1/1343

(52) U.S. Cl. CPC G02F 1/134309; G02F 2201/123

(57) ABSTRACT

A pixel electrode structure is provided. The pixel electrode structure includes a main pixel electrode and a sub-pixel electrode. In the main pixel electrode, A first incision is disposed between a first transverse frame and a first longitudinal frame, and a second incision is disposed between the first transverse frame and a second longitudinal frame. In the sub-pixel electrode, a third incision is disposed between a second transverse frame and a third longitudinal frame, and a fourth incision is disposed between the second transverse frame and a fourth longitudinal frame.

### CROSS REFERENCE TO RELATED APPLICATIONS

This application claims the priority of Chinese Application No. 201911036519.4, filed on Sep. 5, 2017, entitled “PIXEL ELECTRODE STRUCTURE”. The entire disclosures of each of the above applications are incorporated herein by reference.

### FIELD OF INVENTION

The present disclosure relates to the technical field of display panels, and in particular, relates to a pixel electrode structure.

### BACKGROUND OF INVENTION

The transmittance of a liquid crystal display panel is mainly affected by three physical factors, which are the total absorption transmittance, the absolute aperture ratio, and the liquid crystal efficiency of the film layer in the penetrating region. When the product technology is advanced, how to use the design of the pixel electrode pattern to improve the liquid crystal efficiency without changing the absorption of the film layer and the size of the opening area has become an important way to improve the transmittance. Theoretically, the pixel electrode generates a corresponding electric field according to the pattern of the pixel electrodes after applied a current, thereby inducing liquid crystal molecules in different regions to fall in different directions.

### Technical Problem

Obviously, in the specific applications, the pixel electrode may be affected by different objective conditions and cannot achieve the desired effect. As shown in FIG. 1, in the 8-domain pixel electrode array in the existing vertical alignment (VA) liquid crystal display panel, for a single pixel electrode 10, the electric field is single, the liquid crystal molecules are simple to arrange, and it is easy to reach a preset state. However, between two adjacent pixel electrodes 10, as shown in FIG. 2 and FIG. 6, specifically in the corners where the main pixel electrode and the sub pixel electrode are close to each other in two adjacent pixel electrodes, due to the influence of liquid crystal display panels, such as data traces, DBS electrodes, main pixel electrodes, sub-pixel electrodes, and other common electrode electric fields, it is not adverse to the convergence of the dark lines of the liquid crystal, which reduces the liquid crystal efficiency, thereby reducing the transmittance of the display panel.

### SUMMARY OF INVENTION

### Solution to Problem

An object of the present disclosure is to provide a pixel electrode structure, which solve the problem that the electric field between two adjacent pixel electrodes is complicated, which affects the convergence of liquid crystal dark lines and reduces the transmittance of the display panel in the 8-domain pixel electrode array.

To achieve the above object, the present disclosure provides a pixel electrode structure, the pixel electrode structure includes a main pixel electrode and a sub-pixel electrode;

wherein the main pixel electrode comprises a main pixel frame including a first transverse frame located on a side of the main pixel electrode away from the sub-pixel electrode, a first longitudinal frame, and a second longitudinal frame; the first longitudinal frame and the second longitudinal frame are respectively located at two ends of the first transverse frame and extend toward the sub-pixel electrode; a first incision is disposed between the first transverse frame and the first longitudinal frame, and a second incision is disposed between the first transverse frame and the second longitudinal frame;

wherein the sub-pixel electrode comprises a sub-pixel frame including a second transverse frame located on a side of the sub-pixel electrode away from the main pixel electrode, a third longitudinal frame, and fourth longitudinal frame; the third longitudinal frame and the fourth longitudinal are respectively located at two ends of the second transverse frame and extend toward the main pixel electrode; a third incision is disposed between the second transverse frame and the third longitudinal frame, and a fourth incision is disposed between the second transverse frame and the fourth longitudinal frame.

In the pixel electrode structure of the present disclosure, the main pixel electrode includes a main electrode pattern disposed in the main pixel frame; the main electrode pattern at least includes a first slit and a second slit, the first slit is connected to the first incision and an axis of the first slit is collinear with an axis of the first incision; the second slit is connected to the second incision and an axis of the second slit is collinear with an axis of the second incision.

In the pixel electrode structure of the present disclosure, a width of the first incision is equal to a width of the first slit.

In the pixel electrode structure of the present disclosure, a width of the second incision is equal to a width of the second slit.

In the pixel electrode structure of the present disclosure, the main electrode pattern further includes a main cross backbone; the first slit extends from the main cross backbone to the first incision for connecting the first slit with the first incision; the second slit extends from the main cross backbone to the second incision for connecting the second slit with the second incision.

In the pixel electrode structure of the present disclosure, the axis of the first incision is perpendicular to the axis of the second incision.

In the pixel electrode structure of the present disclosure, the sub-pixel electrode includes a sub-electrode pattern disposed in the sub-pixel frame; the sub-electrode pattern at least includes a third slit and a fourth slit; the third slit is connected to the third incision, and an axis of the third slit is collinear with an axis of the third incision; the fourth slit is connected to the fourth incision, and an axis of the fourth slit is collinear with an axis of the incision.

In the pixel electrode structure of the present disclosure, a width of the third incision is equal to a width of the third slit.

In the pixel electrode structure of the present disclosure, a width of the fourth incision is equal to a width of the fourth slit.

In the pixel electrode structure of the present disclosure, the axis of the third incision is perpendicular to the axis of the fourth incision.

In the pixel electrode structure of the present disclosure, the sub-electrode pattern further includes a sub-cross backbone; the third slit extends from the sub-cross backbone for connecting the third slit with the third incision; the fourth slit extends form the sub-cross backbone for connecting the fourth slit with the fourth incision.

In the pixel electrode structure of the present disclosure, a control component is provided between the main pixel electrode and the sub-pixel electrode, and the control component is electrically connected to the main pixel electrode and the sub-pixel electrode, respectively.

### Advantageous Effects of Invention

Compared with the prior art, by changing the structure of the main pixel frame and the sub-pixel frame of 8-domain in the present disclosure, the first incision is disposed between the first transverse frame and the first longitudinal frame, the second incision is disposed between the first transverse frame and the second longitudinal frame, the third incision is disposed between the second transverse frame and the third longitudinal frame, and the fourth incision is disposed between the second transverse frame and the fourth longitudinal frame. Thereby, the cutting process can be implemented at each of the corners of the main pixel frame and the sub-pixel frame. In the 8-domain pixel electrode array, the alignment dark lines at each of the corners of the main pixel frame or at each of the corners of the sub-pixel frame between two adjacent 8-domain pixel electrodes are improved. Therefore, the liquid crystal efficiency is improved, and the transmittance of the display panel is improved.

### DESCRIPTION OF DRAWINGS

In order to more clearly illustrate technical solutions in embodiments of the present disclosure, the drawings used in the description of the embodiments will be briefly introduced below. Obviously, the drawings in the following description are only some embodiments of the present disclosure, and those skilled in the art can obtain other drawings according to these drawings without any creative effort.

FIG. 1 is a schematic view of a conventional pixel electrode structure array.

FIG. 2 is a partially enlarged schematic view at A in FIG. 1.

FIG. 3 is a schematic view of an array of pixel electrode structures according to an embodiment of the present disclosure.

FIG. 4 is a partially enlarged schematic view at B in FIG. 3.

FIG. 5 is a schematic view of a pixel electrode structure according to an embodiment of the present disclosure.

FIG. 6 is a schematic view of the optical performance of a conventional pixel electrode structure array at A.

FIG. 7 is a schematic view of the optical performance of the pixel electrode structure array at B according to an embodiment of the present disclosure.

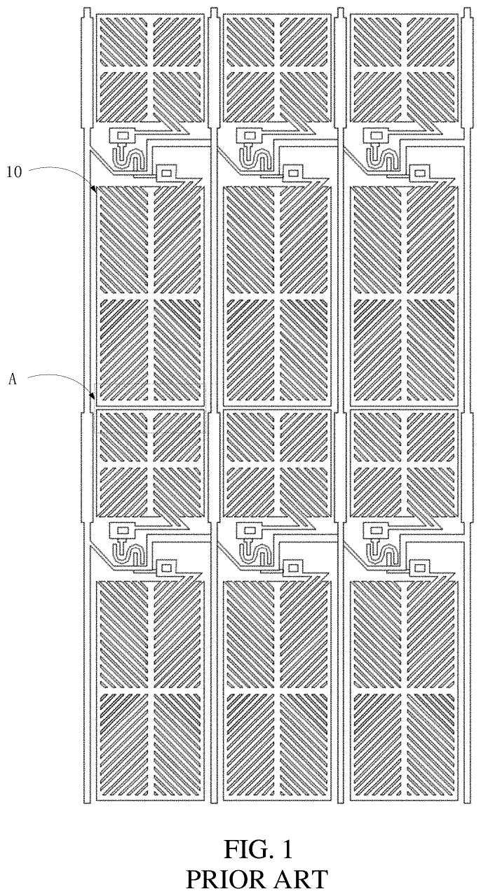

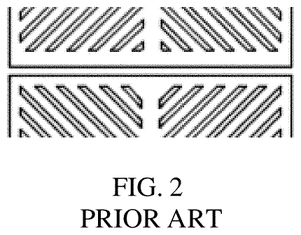

### DETAILED DESCRIPTION OF PREFERRED EMBODIMENTS

The present disclosure provides a pixel electrode structure. In order to make the purpose, technical solution, and effect of the present disclosure clearer, the following further describes the present application in detail with reference to the drawings and examples. It should be understood that the specific embodiments described herein are only used to explain the present disclosure, and are not used to limit the present disclosure.

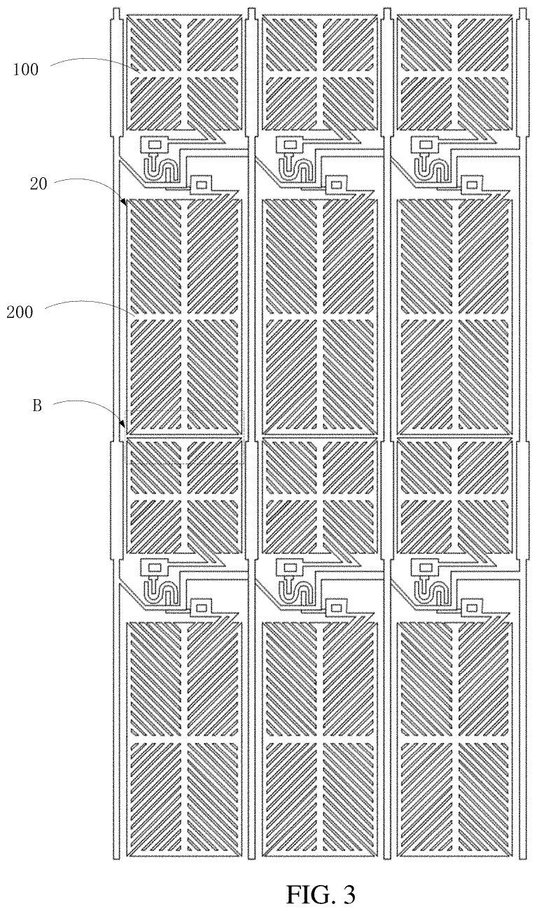

The embodiment of the present disclosure provides a pixel electrode structure 20. In one embodiment, an 8-domain pixel electrode structure is used as an example. The pixel electrode structure 20 includes a main pixel electrode 100 and a sub-pixel electrode 200, as shown in FIG. 3 to FIG. 5.

The main pixel electrode 100 comprises a main pixel frame 110 including a first transverse frame 111 located on a side of the main pixel electrode 100 away from the sub-pixel electrode 200, a first longitudinal frame 112, and a second longitudinal frame 113. The first longitudinal frame 112 and the second longitudinal frame 113 are respectively located at two ends of the first transverse frame 111 and extend toward the sub-pixel electrode 200. A first incision 114 is disposed between the first transverse frame 111 and the first longitudinal frame 112, and a second incision 115 is disposed between the first transverse frame 113 and the second longitudinal frame 115.

The sub-pixel electrode 200 comprises a sub-pixel frame 210 including a second transverse frame 211 located on a side of the sub-pixel electrode 200 away from the main pixel electrode 100, a third longitudinal frame 212, and fourth longitudinal frame 213. The third longitudinal frame 212 and the fourth longitudinal frame 213 are respectively located at two ends of the second transverse frame 211 and extend toward the main pixel electrode 100. a third incision 214 is disposed between the second transverse frame 211 and the third longitudinal frame 212, and a fourth incision 215 is disposed between the second transverse frame 211 and the fourth longitudinal frame 213.

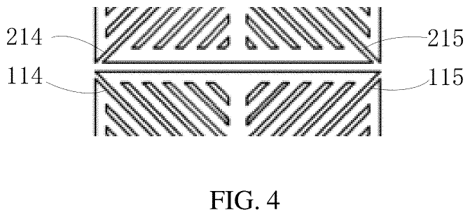

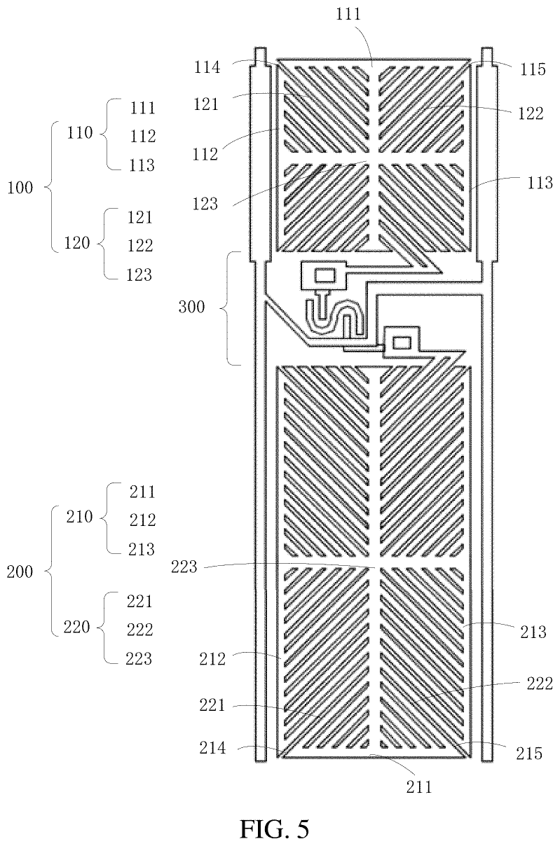

Understandably, shown in FIG. 5, in the pixel electrode structures 20, the first incision 114, the second incision 115, the third incision 214, and fourth incision 215 are respectively located at the corner positions of the pixel electrode structure 20. In an array composed of the pixel electrode structures 20, a cutting process of the corner is implemented between two adjacent pixel electrode structures 20 in the respective pixel structures. As shown in FIG. 4, in the pixel electrode structures 20 adjacent to each other in FIG. 3, a structure undergoing the cutting process at each corner in the sub-pixel electrode 200 of the pixel electrode structure 20 above and the main pixel electrode 100 of the pixel electrode structure 20 below stablizes the electric field at each corner of the pixel electrode structure 20, so that the liquid crystal molecules can fall in a predetermined direction. As a result, the dark lines at the corners of the pixel electrode structure 20 are well converged.

Specifically, the first incision 114 and the second incision 115 are located at two corners of the main pixel electrode 100 away from the sub-pixel electrode 200, respectively. The cutting process of the corner is implemented at the corners between the first transverse frame 111 and the first longitudinal frame 112 and between the first transverse frame 111 and the second longitudinal frame 113. Similarly, the third incision 214 and the fourth incision 215 are respectively located at two corner of the sub-pixel electrode 200 away from the main pixel electrode 100. According to the above structure, it can improve the phenomenon that the original pixel electrode is affected by the liquid crystal display panel at the corners, such as data trace, DBS electrodes, main pixel electrode 100, sub-pixel electrode 200, and other common electrode electric fields, and the convergence of the dark lines is poor. The liquid crystal efficiency at the corners of the pixel boundary is improved, thereby improving the transmittance of the display panel.

In one embodiment, the main pixel electrode 100 includes a main electrode pattern 120 disposed in the main pixel frame 110; the main electrode pattern 120 at least includes a first slit 121 and a second slit 122, the first slit 121 is connected to the first incision 114 and an axis of the first slit 121 is collinear with an axis of the first incision 114; the second slit 122 is connected to the second incision 115 and an axis of the second slit 122 is collinear with an axis of the second incision 115. In addition, the sub-pixel electrode 200 includes a sub-electrode pattern 220 disposed in the sub-pixel frame 210; the sub-electrode pattern 220 at least includes a third slit 221 and a fourth slit 222; the third slit 221 is connected to the third incision 214, and an axis of the third slit 221 is collinear with an axis of the third incision 214; the fourth slit 222 is connected to the fourth incision 215, and an axis of the fourth slit 222 is collinear with an axis of the incision 215.

It can be understood that this embodiment takes the 8-domain pixel electrode structure 20 as an example. As shown in FIG. 3 and FIG. 4, the main electrode pattern 120 further includes a main cross backbone 123; the first slit 121 extends from the main cross backbone 123 to the first incision 114, and the second slit 122 extends from the main cross backbone 123 to the second incision 115. The sub-electrode pattern 220 further includes a sub-cross backbone 223; the third slit 221 extends from the sub-cross backbone 223 to the third incision 214; the fourth slit 222 extends form the sub-cross backbone 223 to the fourth incision 215. Obviously, the main electrode pattern 120 and the sub-electrode pattern 220 further include a plurality of slit patterns parallel to the first slit 121, the second slit 122, the third slit 221, or fourth silt 222. So that the main electrode pattern 120 and the sub-electrode pattern 220 have a “meter-shaped structure”. Specifically, the axis of the first incision 114 is perpendicular to the axis of the second incision 115, and the first slit 121 and the second slit 122 may be inclined at 45 degrees and 135 degrees, respectively. The axis of the third incision 214 is perpendicular to the axis of the fourth incision 215, and the third slit 221 and the fourth slit 222 may be inclined at 45 degrees and 135 degrees, respectively.

A width of the first incision 114 is equal to a width of the first slit 121. A width of the second incision 115 is equal to a width of the second slit 122. A width of the third incision 214 is equal to a width of the third slit 221. A width of the fourth incision 215 is equal to a width of the fourth slit 222. Specifically, the widths of the first slit 121, the second slit 122, the third slit 221, and the fourth slit 222 are all equal, so that the first incision 114, the second incision 115, the third incision 214, and fourth incision 215 are equal. The improved pattern of this electrode is simple and the structure is simple. In the original manufacturing process, the cutting process of the corner is implemented along the extending direction of the first slit 121, the second slit 122, the third slit 221, and fourth slit 222 to the main pixel frame 110 and the sub-pixel frame 210.

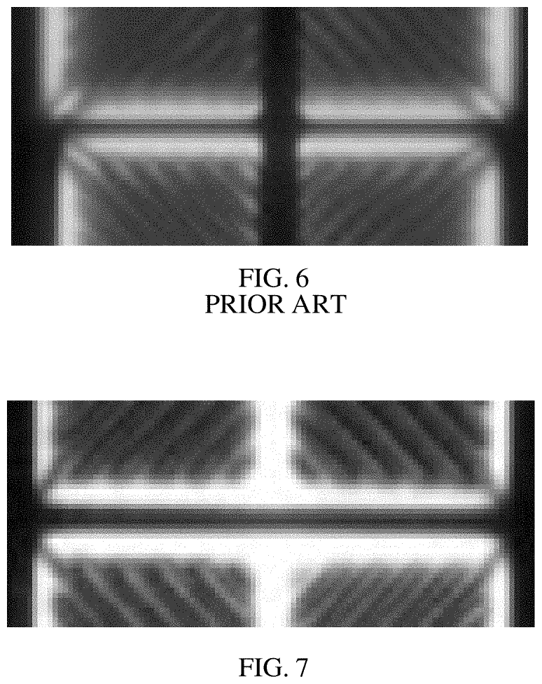

In one embodiment, a control component 300 is provided between the main pixel electrode 100 and the sub-pixel electrode 200, and the control component 300 is electrically connected to the main pixel electrode 100 and the sub-pixel electrode 200, respectively. Obviously, the specific structure of the control component 300 may be, but is not limited to, a 3T1C driving structure, and details are not described herein. As shown in FIG. 6 and FIG. 7, the cutting process of the corner is implemented on the main pixel frame 110 and the sub-pixel frame 210. Obviously, the structure has a better convergence effect of dark lines than the original structure, so the liquid crystal efficiency of the pixel electrode structure 20 at the corners of the pixel boundary is improved, and the transmittance of the liquid crystal display panel is also improved.

Above all, by changing the structure of the main pixel frame 110 and the sub-pixel frame 210 of 8-domain in the present disclosure, the first incision 114 is disposed between the first transverse frame 111 and the first longitudinal frame 112 of the main pixel frame 110; the second incision 115 is disposed between the first transverse frame 111 and the second longitudinal frame 113; the third incision 214 is disposed between the second transverse frame 211 and the third longitudinal frame 212 of the sub-pixel frame 210; and the fourth incision 215 is disposed between the second transverse frame 211 and the fourth longitudinal frame 213. Thereby, the cutting process can be implemented at each of the corners of the main pixel frame 110 and the sub-pixel frame 210. In the 8-domain pixel electrode array, the alignment dark lines at each of the corners of the main pixel frame 110 or at each of the corners of the sub-pixel frame 210 between two adjacent 8-domain pixel electrodes are improved. Therefore, the liquid crystal efficiency is improved, and the transmittance of the display panel is improved.

It can be understood that, for a person of ordinary skill in the art, equivalent replacements or changes can be made according to the technical solution of the present disclosure and its inventive concept. All changes or substitutions should fall within the protection scope of the claims attached to the present disclosure.

What is claimed is:

1. A pixel electrode structure, comprising:
a main pixel electrode and a sub-pixel electrode;
wherein the main pixel electrode comprises a main pixel frame including a first transverse frame located on a side of the main pixel electrode away from the sub-pixel electrode, a first longitudinal frame, and a second longitudinal frame;
the first longitudinal frame and the second longitudinal frame are respectively located at two ends of the first transverse frame and extend toward the sub-pixel electrode; a first incision is disposed between the first transverse frame and the first longitudinal frame, and a second incision is disposed between the first transverse frame and the second longitudinal frame;
wherein the sub-pixel electrode comprises a sub-pixel frame including a second transverse frame located on a side of the sub-pixel electrode away from the main pixel electrode, a third longitudinal frame, and fourth longitudinal frame; the third longitudinal frame and the fourth longitudinal frame are respectively located at two ends of the second transverse frame and extend toward the main pixel electrode; a third incision is disposed between the second transverse frame and the third longitudinal frame, and a fourth incision is disposed between the second transverse frame and the fourth longitudinal frame.

2. The pixel electrode structure according to claim 1, wherein the main pixel electrode includes a main electrode pattern disposed in the main pixel frame; the main electrode pattern at least includes a first slit and a second slit, the first slit is connected to the first incision and an axis of the first slit is collinear with an axis of the first incision; the second slit is connected to the second incision and an axis of the second slit is collinear with an axis of the second incision.

3. The pixel electrode structure according to claim 2, wherein a width of the first incision is equal to a width of the first slit.

4. The pixel electrode structure according to claim 2, wherein a width of the second incision is equal to a width of the second slit.

5. The pixel electrode structure according to claim 2, wherein the axis of the first incision is perpendicular to the axis of the second incision.

6. The pixel electrode structure according to claim 2, wherein the main electrode pattern further includes a main cross backbone; the first slit extends from the main cross backbone to the first incision for connecting the first slit with the first incision; the second slit extends from the main cross backbone to the second incision for connecting the second slit with the second incision.

7. The pixel electrode structure according to claim 1, wherein the sub-pixel electrode includes a sub-electrode pattern disposed in the sub-pixel frame; the sub-electrode pattern at least includes a third slit and a fourth slit; the third slit is connected to the third incision, and an axis of the third slit is collinear with an axis of the third incision; the fourth slit is connected to the fourth incision, and an axis of the fourth slit is collinear with an axis of the incision.

8. The pixel electrode structure according to claim 7, wherein a width of the third incision is equal to a width of the third slit.

9. The pixel electrode structure according to claim 7, wherein a width of the fourth incision is equal to a width of the fourth slit.

10. The pixel electrode structure according to claim 7, wherein the axis of the third incision is perpendicular to the axis of the fourth incision.

11. The pixel electrode structure according to claim 7, wherein the sub-electrode pattern further includes a sub-cross backbone; the third slit extends from the sub-cross backbone for connecting the third slit with the third incision; the fourth slit extends form the sub-cross backbone for connecting the fourth slit with the fourth incision.

12. The pixel electrode structure according to claim 1, wherein a control component is provided between the main pixel electrode and the sub-pixel electrode, and the control component is electrically connected to the main pixel electrode and the sub-pixel electrode, respectively.
